(19) United States
(12) Patent Application Publication
(10) Pub. No.: US 2009/0183078 A1
(43) Pub. Date: Jul. 16, 2009

(54) INSTANT FEEDBACK MEDIA EDITING SYSTEM

(75) Inventors: Manuel Clement, Bellevue, WA (US); Christopher Weare, Bellevue, WA (US); Jeffrey T. Pearce, Seattle, WA (US); Adil A. Sherwani, Boston, MA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/013,878

(22) Filed: Jan. 14, 2008

(51) Int. Cl. G06F 3/00

(52) U.S. Cl. 715/723

(57) ABSTRACT

Methods and systems are provided herein for a user to edit audio or video content to further obtain a desired edited content and immediately preview an edited content. In accordance with a method of the present invention, audio or video content is received and displayed as a signal waveform. The method further includes user inputs to edit the content wherein the user inputs determine the regions of one or more cropped regions and one or more active regions and previews the active regions of the active region. Additionally, the method provides an immediate preview of the edited audio or video content.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Audio and video content editing systems are typically limited to professional use. Therefore, it is difficult for a casual user to have access to professional content editing programs for their everyday use. Today, current editing systems lack the functionality to give the casual user the desired experience. Also, professional programs are to cumbersome and complicated to use. Other issues with current editing systems include the user interfacing through several dialog boxes and screen displays to edit a simple audio or video content piece. This requires the user to learn complicated interfaces from several editing programs whereby the user switches back and forth between the dialog boxes or the screen displays. For example, the user wanting to capture the chorus of a favorite song needs several displays and dialog boxes to achieve the recorded fragment of the chorus. Such editing programs require a screen display to receive the audio content, a separate screen to display the content, a third display screen to edit the content, and a fourth display screen to save the desired content. These activities are inefficient and costly since inconsistencies may occur from the interaction of several display programs.

Additional problems with current content editing systems include the destruction of edited audio or video content. For example, once a user edits audio or video content and saves any current settings to the content, the user cannot readily change the content again to obtain a portion of the waveform that was deleted. The user must download the original audio or video again or at least start form the original audio or video.

### SUMMARY

Embodiments of the present invention provide methods and systems to display, preview, and edit audio or video content. One aspect of the present invention is to provide an editing method, capable of instantly communicating edited audio or video content as a preview, playback, etc. In various other embodiments the audio or video content can be displayed as a time representation, text representation, or other sort representation. The method receives audio or video content and displays this content as a representation of on a screen display on a computing device. Further, a user alters the audio or video content by receiving inputs from an input device removing a portion of the content to produce an altered content. One aspect of the present invention immediately displays a preview of the altered content based on a receipt of receiving input. Furthermore, this embodiment includes receiving additional inputs to produce display another altered content on the single screen display. This enables a user to use a single screen rather than switching to several screens on a computing device display. The method also allows the user to preview the edited content on the computing device display to determine the desired altered content. Additionally, the method allows a user to alter the modified content by receiving additional user inputs. This additional alteration to the modified content can consist of either the subsets of the original received content or the modified content or combination thereof. Additionally, the method presents the alteration to the modified content on a screen in a visual manner and directly allows a user to preview the alterations to any content.

In yet another aspect of the invention, a method is presented to depict edited content to a user based on receiving edit controls displayed on a screen by means of an input device such as a mouse, keyboard, touch screen, etc. This method displays received audio or video content on the screen display as a signal waveform and edits occur to the signal waveform. Another embodiment of the present invention separates an edited content waveform into one or more cropped regions and one or more active region based on user edit controls. The active region is the portion of the edited content waveform that is included in a playback or preview. The cropped region is the portion of the edited content waveform visually represented as discarded or removed. Embodiments of this aspect include representing the cropped region in a visually different manner on the screen display than the active regions. Examples include shading, hatching, coloring, etc.

In a further embodiment of the present invention, a system is presented having a computing system operating with one or more software programs to display audio or video content, calculate an optimal point to preview the audio or video content, and associate a record of the audio or video content in memory. The software program receives user inputs to edit the audio or video content. The user inputs are located visually on the display of the computing system and are operable according to an input device. By way of example and not of limitation such input devices can include a mouse, keyboard, or touch screen to edit the audio or video content. Based on receiving the user input edit controls to edit the audio or video content, an additional temporary record is created in memory. Furthermore, a permanent record of the edited content is not stored until a user prompts to store the edited content. In yet a further aspect, additional edits are received so the edited content can include subsets of the original content.

Additionally, according to the present invention, it is possible to provide a storage medium for storing therein procedure of the above-described editing method in a format of a program code read/executed by a computer.

It should be noted that this Summary is provided to generally introduce the reader to one or more select concepts described below in the Detailed Description in a simplified form. The Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a screen display of an exemplary audio or video content used in an implementation of an embodiment of the present invention;

FIG. 2 is a screen display of an exemplary audio or video content that has been edited while implementing an embodiment of the present invention;

FIG. 3 is a screen display of another exemplary audio or video content that has been edited, and includes a preview screen, while implementing an embodiment of the present invention;

FIG. 4 is an exemplary flowchart for editing audio or video content in a single screen display while operating an embodiment of the present invention;

FIG. 5 is an exemplary flowchart for editing audio or video content into cropped regions and active regions on a single screen display while operating an embodiment of the present invention; and

FIG. 6 is an exemplary flowchart for operating an exemplary editing system while implementing an embodiment of the present invention.

### DETAILED DESCRIPTION

Embodiments of the present invention may be described in the general context of computer code or machine-usable instructions, including computer-executable instructions such as program modules, being executed by a computer or other machine, such as a personal data assistant or other handheld device. The phrase “computer-usable instructions” may be used herein to include the computer code and machine-usable instructions. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network. In a distributed computing environment, program modules or software programs may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

From the foregoing, it will be seen that this invention is one well-adapted to attain the ends and objects set forth above, together with other advantages which are obvious and inherent to the methods, computer-readable media, and systems. It will be understood that certain features and sub-combinations are of utility and may be employed without reference to other features and sub-combinations. This is contemplated by and within the scope of the claims.

Referring to the following figures, it should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions in memory.

The subject matter of the present invention is described with specificity herein to meet statutory requirements. However, the description itself is not intended to limit the scope of the patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various items herein disclosed unless and except when the order of the individual steps is explicitly described.

### Instant Feedback Media Editing System

Accordingly, in one aspect, the present invention is directed to one or more computer-readable media having computer-usable instructions embodied thereon for performing a method for editing audio and video content. Embodiments of the present invention operate to display, preview, and edit audio or video content. One aspect of the present invention is to provide an editing method capable of instantly communicating edited audio or video content as a preview, playback, etc. In various other embodiments, the audio or video content can be displayed on a display device as a function of time. Audio or video content is received at a computing device and displayed on a screen display. A user operating the computing device alters the audio or video content by providing inputs into the computing device in a manner where a portion of the audio or video content is removed to produce an altered audio or video content. When this alteration occurs, the user can immediately preview the altered audio or video content or a portion thereof. Subsequently, the user can provide additional inputs to produce another altered audio or video content on the single screen display without changing to another screen display. While using the single screen display, the user can edit and preview the audio or video content numerous times to determine a start and end point for the desired altered audio or video content.

In another aspect, audio or video content is depicted as a waveform to a user on a screen display. The user provides input to the computing device which results in an edited content. As the user provides inputs by way of an input device such as a mouse, keyboard, touch screen, etc., the input actions are viewed visually as edit controls or edit markers displayed on the screen display. Both the edit controls or edit markers and the waveform are viewed together on the screen display. Subsequently, the edit controls or edit markers and the edited content are viewed together on the screen display.

When the user provides inputs into the computing device, the visually-shown waveform becomes separated into an active region that holds the edited content and a cropped regions which holds the discarded or removed waveform. As the inputs occur, the user can see the edit controls or edit markers delineate the boundaries between the active region and the cropped region. In an implementation of an embodiment of the present invention, the active region may be depicted different visually on the screen display from the cropped region. For example, one region can be shaded while the other region can be un-shaded. In another example, one region can be depicted in a particular color while the other region can be depicted in another color.

In yet another aspect, an editing system includes a computer with a processor, memory, and software programs to display audio or video content, to calculate an optimal point to preview the audio or video content, and to associate a record of the audio or video content in memory. The software programs receive user inputs to edit the audio or video content. The user inputs are simultaneously shown visually on a display of the computer. By way of example and not of limitation, the user inputs are received into the computer by such input devices as a mouse, keyboard, or touch screen to edit the audio or video content. At the start, a temporary record of the audio or video content is created in memory. As the user inputs are received, this temporary record is manipulated to hold the edited content. Once the user has completed the manipulation of the audio or video content, which is simultaneously shown on the display, a permanent record of the edited content is stored when the user prompts to store the edited content. It is noted that more than one temporary record may occur as the user edits the audio or video content. Each record is stored in memory until the user initiates an action to create a permanent record signifying a saving of the edited content.

Having briefly described an overview of embodiments of the present invention, an exemplary method of editing audio and video content is described herein.

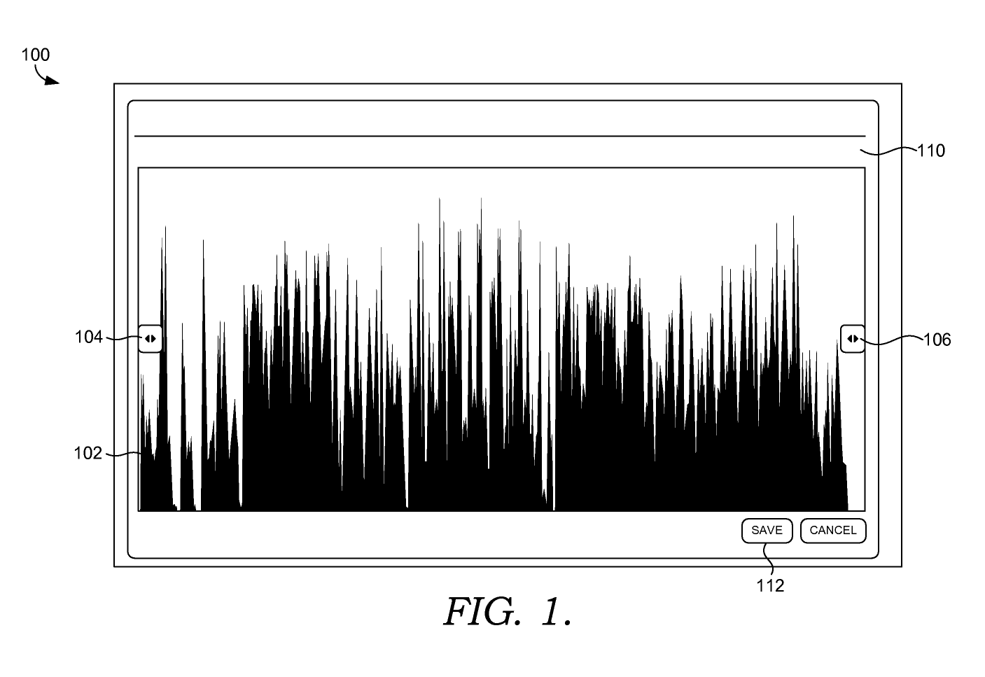

As shown in FIG. 1, an exemplary display 100 is shown with a waveform 102, edit markers 104 and 106, an application 110, and a save button 112. Display 100 is typically associated with a screen display directly connected to a computing device. However, display 100 may be connected to the computing device over a network connection. Examples of display 100 can include a monitor.

Waveform 102 is located within application 110. Waveform 102 represents an audio or video content that is stored in a data structure at or near the computing device. Although not shown, a user can provide various inputs to hear or see the audio or video content represented by waveform 102. Typically, waveform 102 is shown as a function of time. So, the start point of waveform 102 is the left edge while the end point of waveform 102 is the right edge as shown in application 110.

Along with waveform 102, edit markers 104 and 106 are shown in application 110. Edit markers 104 and 106 represent the boundaries of waveform 102 where edit marker 104 is associated with the left edge of waveform 102 and edit marker 106 is associated with the right edge of waveform 102. Edit markers 104 and 106 are displayed visually as indicated in application 110. Edit markers 104 and 106 are used to adjust the audio and/or video content to produce an edited content which results in a visually displayed edited waveform. In FIG. 1, edit markers 104 and 106 move horizontally according to the user's inputs to adjust waveform 102. However, the present invention is not so limited as embodiments of the present invention can implement edit markers 104 and 106 to move diagonally, vertically, etc. Additionally, although only edit markers 104 and 106 are depicted, other implementations of an embodiment can include one edit marker or several edit markers. Edit markers 104 and 106 are controlled by way of inputs into the computing device using a mouse, keyboard, joystick, touch screen, etc.

Typically, waveform 102 is a visual representation of the audio or video content that is stored in memory, which in turn, is a copy or edited version of the audio or video content stored in a permanent storage such as a disk. Any changes that occur to the audio or video content in memory can be saved to the disk by the user selecting save button 112. Discussions regarding the editing of the audio or video content shall be discussed further below.

Application 110 is illustrated as a user interface depicted in display 100. As described above, application 110 includes various components. In addition to being the user interface, application 110 represents a software program that is executed by the user on the computing device. The user manipulates waveform 102 through application 110.

All the components depicted in FIG. 1 are exemplary representations which may change depending on the implementation of the embodiment.

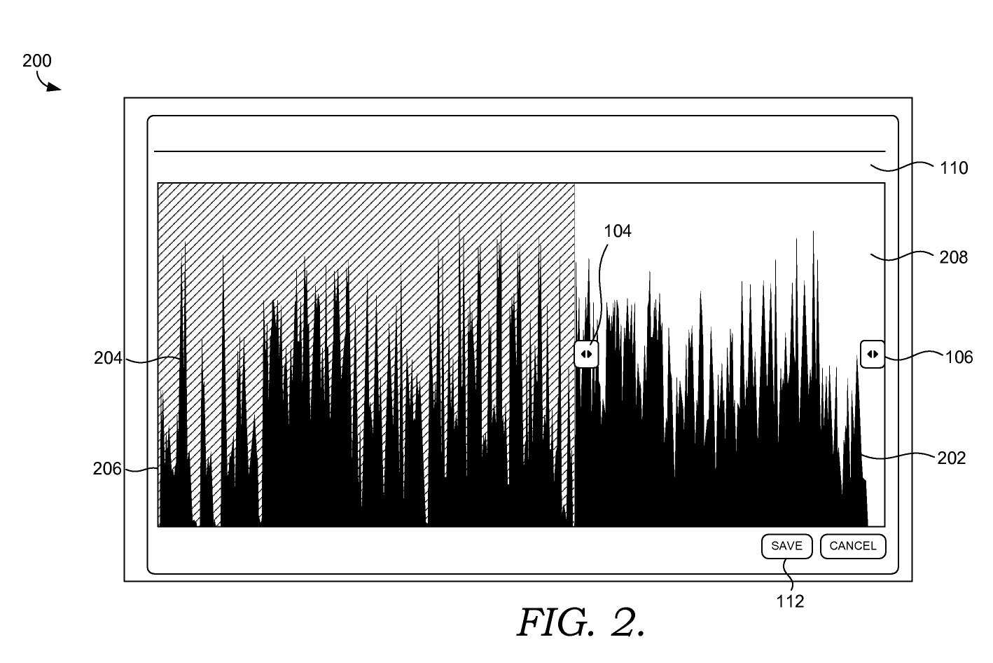

Turning now to FIG. 2, an exemplary display 200 is shown with an edited waveform 202, a discarded waveform 204, a shaded area 206, an ordinary area 208, edit markers 104 and 106, application 110, and save button 112. Display 200 is similar to display 100.

Edited waveform 202 and discarded waveform 204 combine to form waveform 102 from FIG. 1. Edited waveform 202 is created when the user, discussed in FIG. 1, provides inputs into the computing device to edit waveform 102. Inputs are provided using input devices such as a mouse, keyboard, etc. to edit waveform 102. As shown in FIG. 1 and FIG. 2, the user can move edit marker 104 to a desired location over waveform 102. This movement results in edited waveform 202 with a start point located at edit marker 104 in FIG. 2. The remainder of waveform 102 forms discarded waveform 204. Discarded waveform 204 is not truly discarded but becomes an undesirable part of waveform 102. As such, an embodiment of the present invention incorporates shaded area 206 associated with discarded waveform 204 to distinguish discarded waveform 204 from waveform 202 which is located in ordinary area 208.

Another way to illustrate shaded area 206 is to identify it as a cropped region since it includes discarded waveform 204. Another way to illustrate ordinary area 208 is to identify it as an active region since it includes edited waveform 202. It is noted that both edited waveform 202 and discarded waveform 204 may be segmented into one or more active regions and one or more cropped regions depending on the implementation of the embodiment of the present invention.

One of the challenges of using edit markers 104 and 106 is to precisely locate edit markers 104 and 106 in a desired location. The user can precisely determine where to locate edit markers 104 and 106 by previewing a portion of edited waveform 202. For example, with audio content, the user can play a few seconds of audio that begins at edit marker 104. This few seconds of audio can be set to play immediately when edit marker 104 is positioned or repositioned. Or, the few seconds of audio can be played when requested by the user. The same is true for edit marker 106. Edit marker 106 can be the end point, thus, the few seconds can be set to play immediately or on demand starting at a time period before edit marker 106. With edit markers 104 and 106, the user can obtain references of where edited waveform 202 begins and ends.

For video content, the user can visually obtain the start and end points of edit markers 104 and 106 just like the discussion above for audio content. Thus, the user is able to determine if the location of the edit markers is satisfactory.

One of ordinary skill in the art understands that the amount of time allocated for previewing the beginning or ending of edited waveform 202 is changeable. An implementer of an embodiment of the present invention may set the preview times to last from a few seconds to several minutes. The implementer may also allow the user to set the preview times as desired.

In a scenario, the audio or video content displayed in FIG. 2 is received by application 110 operating on the computing device. A copy of this content is stored in memory at or near the computing device. The user edits waveform 102 by positioning edit markers 104 and 106. Wherever edit markers 104 and 106 are placed in application 110 marks the boundaries for edited waveform 202. The rest of waveform 102 comprises discarded waveform 204. The user can continue to re-position edit markers 104 and 106 until a desired edited waveform 202 is achieved.

Within application 110 and the computing device, the changes made to waveform 102 correlate to edits of a record stored in memory. As the user makes subsequent edits, the record may continually be edited or additional records may be created in memory corresponding to the new edits. Once the user is satisfied with the resulting edited waveform 202, the user can select save button 112 to store edited waveform 202 to disk.

In another scenario, waveform 102 is the user's favorite song and the user wants to edit the waveform 102 to capture the chorus of the song. As the user edits the song, the cropped region (shaded area 206) represents the part of the song the user chooses to cut out. As such, this part is not included in any playback or preview of the edited song (edited waveform 202). The active region (ordinary area 208) represents the part of the song the user is interested in previewing. As such, this part is included in the playback or preview of the edited song (edited waveform 202). This part should also include the chorus of the song.

In continuing with the scenario, the user may not like the condition of the edited song and may desire to lengthen or decrease the edited song. The user can re-position edit markers 104 and 106 with an input device to have a new start and end point for the newly edited song (edited waveform 202). For example, the user might have initially decided to exclude the beginning portion of the song. However, subsequently, the user moves edit marker 104 to the left to recapture a portion of the song that was initially removed (discarded waveform 204). The user is able to reincorporate a previously cropped portion into the active region to obtain a new larger active region of the song. Once the user is satisfied with the resulting edited waveform 202, the user can select save button 112 to store edited waveform 202 to disk.

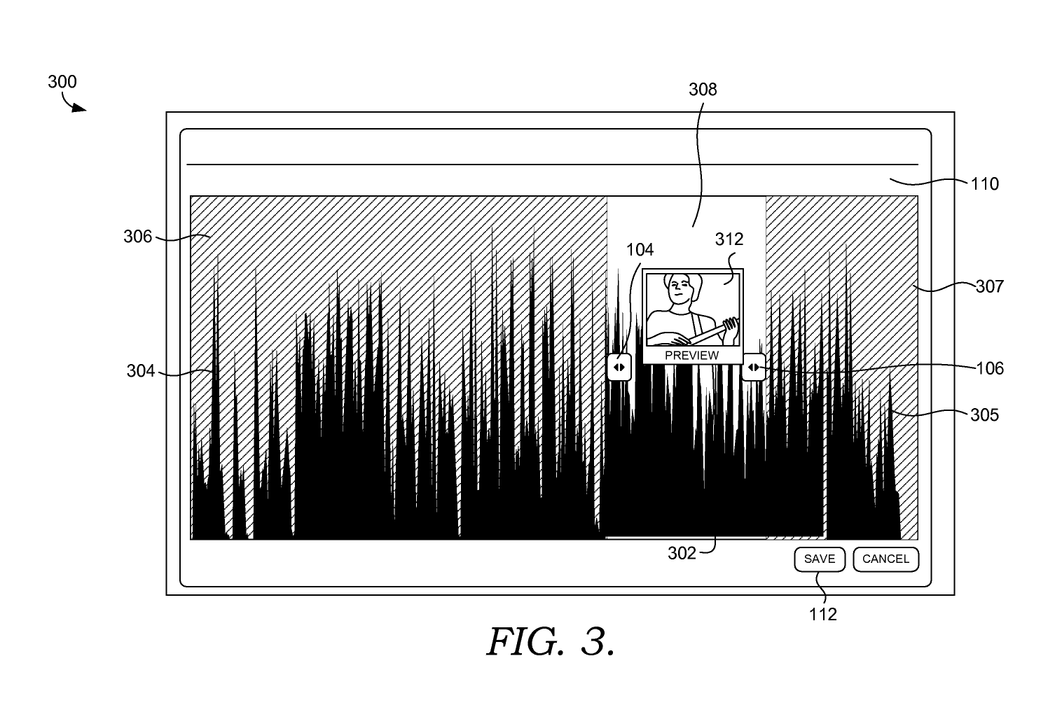

In FIG. 3, an exemplary display 300 is shown with an edited waveform 302, a first discarded waveform 304, a second discarded waveform 305, a first cropped region 306, a second cropped region 307, an active region 308, a video preview 312, edit markers 104 and 106, application 110, and save button 112. Display 300 is similar to display 200 and incorporates the same features. In an implementation of an embodiment, display 300 includes video preview 312 to give the user a visual representation of the video content.

The details of display 300 share many of the same features of display 200 in FIG. 2. However, display 300 illustrates that multiple regions can be discarded (first discarded waveform 304 and second discarded waveform 305) after waveform 102 is edited. First discarded waveform 304 is located in first cropped region 306. Second discarded waveform 305 is located in second cropped region 307. Edited waveform 302 is located in active region 308.

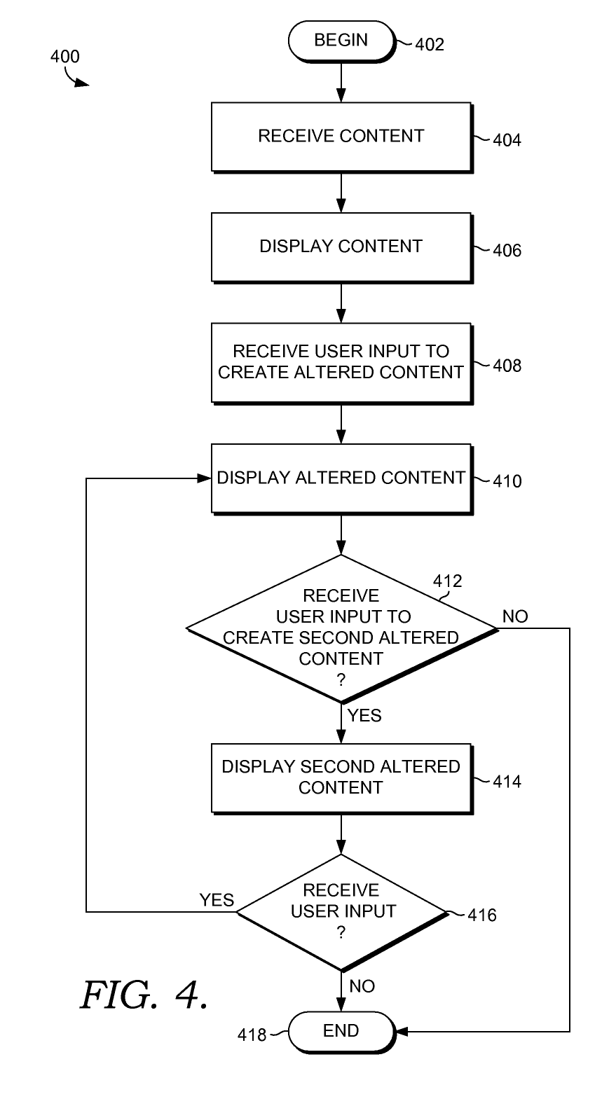

In an implementation of an embodiment of the present invention, a method of altering and previewing audio or video content on a single screen display is depicted by the process in FIG. 4. The method starts at step 402 as indicated by the word BEGIN wherein the method is in a holding period until receiving content 404, while other aspects of step 402 pertain to the method not being executed until receiving content. One aspect of the present invention includes a software application receiving audio or video content 404 and then displaying the content 406 on a single screen display. Embodiments of displaying audio or video content includes generating a waveform, time representation, text representation, or other type of representation on a computing device display. After displaying audio or video content, a software application receives user inputs to create an altered content 408. As described beforehand, receiving user inputs are specified by input devices such as a keyboard, mouse, etc. and reflected visually as edit markers on the screen display. For example, edit markers are adjusted to the left or right as inputs change. As a user provides inputs, the software application receives the user inputs to create an altered audio or video content. The altered content 410 is displayed on the single screen display. One implementation of an embodiment includes separating the content into one or more active regions and one or more cropped regions where the altered content is displayed in the one or more active regions. In the embodiment, the user can provide additional user inputs to create a second altered content 412. The second altered content 412 can be displayed in the same single screen display. If there is no additional user input, the user may stop the editing session at END 418 which also include saving the altered content or second altered content with save button 112.

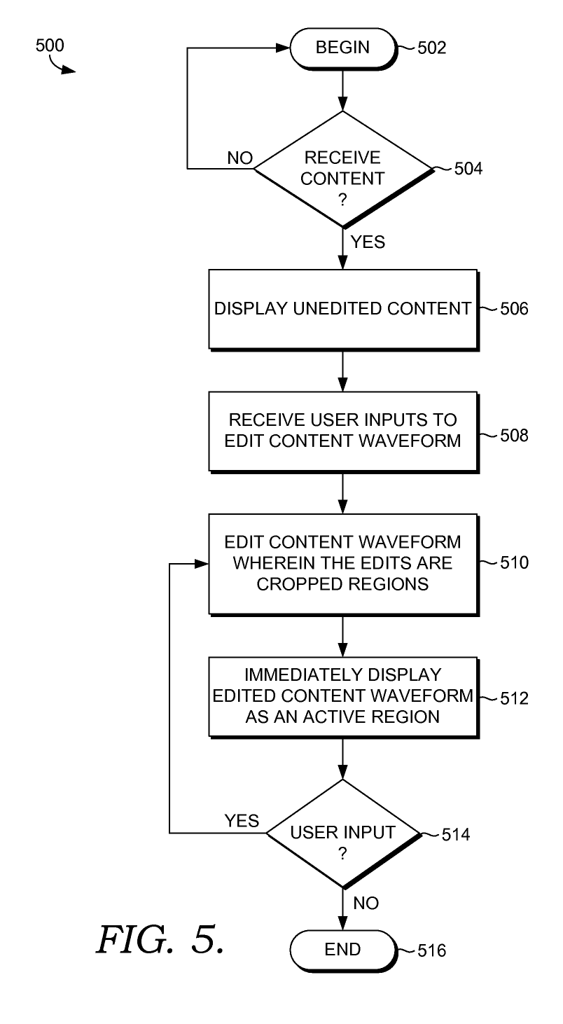

Turning now to FIG. 5, a process for editing audio or video content into cropped regions and active regions on a single screen display is shown in a method 500. In a step 502, method 500 begins. In a step 504, a determination is made whether the audio or video content is received. If the content is received, the original audio or video content is displayed in the single screen display, in a step 506. In a step 508, user inputs are received at a computing device to edit the original audio or video content. The user inputs may be viewed on the single screen display at edit markers 104 and 106. The user inputs causes the edit markers to move across the single screen display over the audio or video content. Wherever the edit markers stop, these location become the starting and ending points for the edited content.

In a step 510, the audio or video content (also known as a content waveform) are edited such that the parts of the content that are not desired or not wanted are discarded into cropped regions. One of ordinary skill in the art knows that although parts of the content waveform may be discarded, the discarded portion may still be viewed by the user on the single screen display.

In a step 512, the portion of the edited waveform that is desired is displayed in an area called an active region on the single screen display. In a step 514, a determination is made whether additional user inputs are received at the computing device. If additional user inputs are received, edit markers 104 and 106 are repositioned to new locations on the single screen display signifying a change in the starting and ending points of the edited audio or video content. Hence, the edited content waveform changes to a new edited content waveform.

As one can see in FIG. 5, the user may continue to modify audio or video content displayed on the single screen display as a content waveform as many times as desired. If the user does not like the result of a first modification, the user can make subsequently modifications without reloading the original audio or video content and without changing to different screen displays to manipulate the content. The user can see the changes on the single screen display. Once the user is satisfied with the changes, the user can make a permanent save of the altered audio or video content with save button 112.

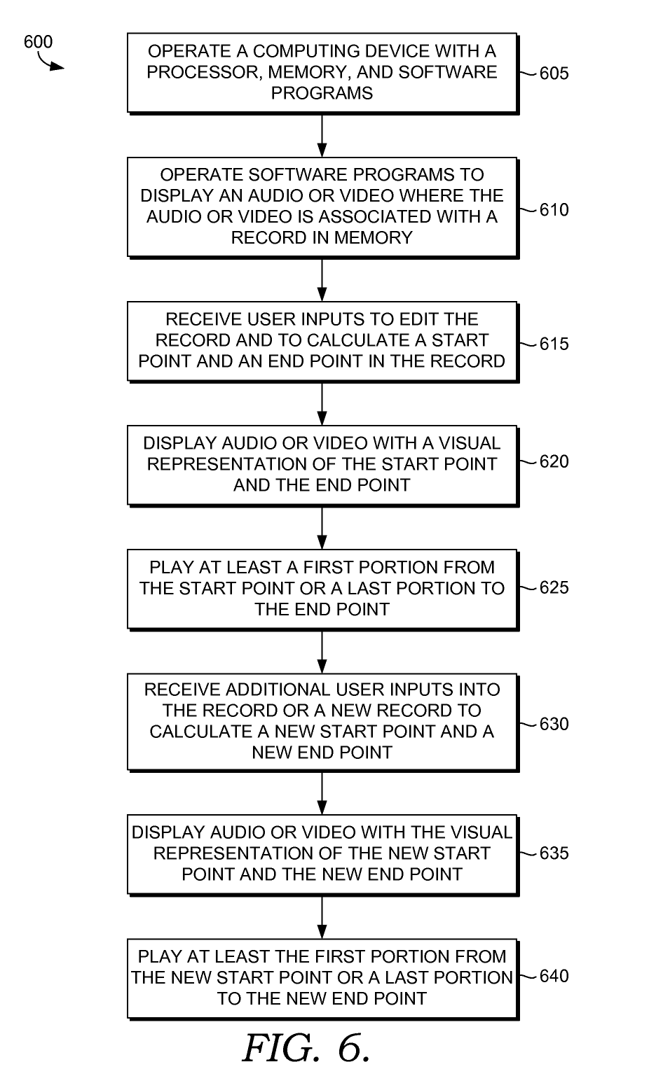

In FIG. 6, a process for operating an exemplary editing system is shown in a method 600, In a step 605, a computing device operates a processor, memory, and software programs. The computing device also has a screen display or is connected to a screen display over a network connection. In a step 610, software programs operate to display audio or video where the audio or video is associated with a record in memory in the computing device.

In a step 615, a user provide user inputs at the computing device to edit the record in memory and to calculate a start point and an end point in the record. In a step 620, the audio or video is displayed on the screen display and a visual representation of the start point and the end point are displayed on the screen display as well. The start point and the end point are the results of user inputs. The visual representation of the start point and the end point may also be called edit markers 104 and 106 discussed above.

In a step 625, a part of the audio or video is played in the form of a first portion from the start point or a last portion to the end point. The first portion or last portion enables the user to determine the exact location for the placement of the start point and the end point in the record, also known as edit markers 104 and 106 shown on the screen display. If the user is not satisfied with the location of the start point and the end point, the user may provide additional user inputs to change the start point and the end point as described in a step 630. In a step 635, similar to step 625, the audio or video is displayed on the screen display with the visual representation of the new start point and the new end point. In a step 640, the first portion is played from the new start point or the last portion is played to the new end point.

As can be seen, the present invention and its equivalents are well-adapted to provide new and useful system and methods for, among other things, editing audio or video content and rewarding the user with an instant preview of the edited content. Many different arrangements of the various components depicted, as well as components not shown, are possible without departing from the spirit and scope of the invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled programmer may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable storage media having computer useable instructions embodied thereon for performing a method for communicating instantly a result of an alteration to a content, the method comprising:
receiving the content on a computing device;
displaying the content on a screen in a display device wherein a user receives an audio representation or a video representation of the content;
receiving one or more first inputs from the user without changing the screen in the display device wherein the one or more first inputs remove a first portion from the content to have a first altered content;
immediately with a first receipt of the one or more first inputs, displaying the first altered content in the screen of the display device wherein the user receives the audio representation or the video representation of the first altered content;
receiving one or more second inputs from the user without changing the screen in the display device to have a second altered content wherein the one or more second inputs at least one of adds a subset of the first portion of the content to the first altered content and removes a second portion from the first altered content; and
immediately with a second receipt of the one or more second inputs, displaying the second altered content in the screen of the display device wherein the user receives the audio representation or the video representation of the second altered content.

2. The media of claim 1, wherein the content is a visual representation of an audio or video signal.

3. The media of claim 2, wherein the audio representation comprises an audio rendition playing for a time period starting from a beginning of the content, the first altered content, or the second altered content; or the audio rendition playing for the time period until an ending of the content, the first altered content, or the second altered content.

4. The media of claim 2, wherein the video representation is selected from a group including a picture, a photo, a graph, and a video stream.

5. The media of claim 1 wherein the display device is communicatively coupled to the computing device.

6. One or more computer-readable storage media having computer useable instructions embodied thereon for performing a method to present edited content to a user, the method comprising:
receiving audio or video content on a computing device;
displaying the audio or video content as an unedited content waveform on a single screen display;
receiving user input controls, which are visually represented on the single screen display, to edit the unedited content waveform into one or more cropped regions and one or more active regions displayed on the single screen display wherein a cropped region is a first portion of the unedited content waveform that is visually represented on the single screen display and has been discarded or removed and the active region is a second portion of the unedited content waveform that is visually represented on the single screen display and has not been discarded nor removed;
editing the unedited content waveform to produce an edited content waveform and a discarded content waveform wherein the user modifies the unedited content waveform according to the user input controls and wherein the edited content waveform is associated with the one or more active regions and the discarded content waveform is associated with the one or more cropped regions; and
displaying instantly the edited content waveform in the one or more active regions and the discarded content waveform in the one or more cropped regions.

7. The media of claim 6, further including previewing at least one of a first section and a second section of the edited content waveform to determine whether the edited content waveform is a desired content.

8. The media of claim 6, wherein the edited content waveform is stored in a data structure.

9. The media of claim 6, further comprising a second screen display to preview edited changes to a video content.

10. The media of claim 6, wherein the one or more active regions are visually represented differently from the one or more cropped regions.

11. The media of claim 7, wherein the one or more cropped regions are displayed shaded and the one or more active regions are displayed un-shaded.

12. The media of claim 7, wherein previewing the at least one of the first section and the second section of the edited content waveform includes previewing the one or more active regions.

13. The media of claim 12, wherein previewing the at least one of the first section and the second section includes playing the at least one of the first section and the second section wherein the first section has a duration of a first time period and the second section has the duration of a second time period.

14. An audio or video editing system, the system comprising:
a computing device having a processor and a memory, the processor operable with one or more software programs;
the one or more software programs operable to display an audio or video, the audio or video associated with a record in the memory;
the one or more software programs operable to receive one or more user inputs to edit the record and to calculate a start point and an end point in the record wherein the audio or video is displayed with a visual representation of the start point and the end point;
the one or more software programs operable to play at least one of a first portion from the start point and a last portion to the end point;
the one or more software programs operable to receive one or more additional user inputs into the record or a new record to calculate a new start point and a new end point wherein the audio or video is displayed with the visual representation of the new start point and the new end point; and
the one or more software programs operable to play the at least one of the first portion from the new start point and the last portion to the new end point.

15. The system of claim 14 comprising one or more user prompts in communication with the memory to permanently save the record.

16. The system of claim 14 further comprising one or more buffering components operable with the software programs to play the at least one of a first portion from the start point and the last portion to the end point.

17. The system of claim 14 further including at least one of an active region and a cropped region of the audio or video displayed with a visual representation of the start point and the end point.

18. The system of claim 14 wherein the audio includes a WMA file or MP3 file.

19. The system of claim 14 wherein the video includes a picture, a graph, and a video stream.

20. The system of claim 14 wherein a preview of an edited video includes a display screen on the of the video.
